(19) United States
(12) Patent Application Publication
(10) Pub. No.: US 2023/0134795 A1
(43) Pub. Date: May 4, 2023

(54) LIQUID FOOD COMPOSITION WITH NO ADDED SUGAR COMPRISING PEA PROTEINS AND NO DAIRY PROTEIN

(71) Applicant: SOCIETE DES PRODUITS NESTLE S.A., Vevey (CH)

(72) Inventor: BENOIT IDIEDER, Villars sur Glane (CH)

(21) Appl. No.: 17/760,486

(22) PCT Filed: Feb. 10, 2021
(86) PCT No.: PCT/EP2021/053239

§ 371 Date: Aug. 10, 2022

(30) Foreign Application Priority Data
Feb. 11, 2020 (EP) 20156623.9

(51) Int. Cl. A23L 11/60; A23C 11/10; A23J 3/14; A23L 33/115; A23L 33/16; A23L 33/155

(52) U.S. Cl. CPC A23L 11/60; A23C 11/103; A23J 3/14; A23L 33/115; A23L 33/16; A23L 33/155

(57) ABSTRACT

The present invention relates generally to the field of liquid food compositions. In particular, the present invention relates to liquid food compositions that contain no added sugar and that can be used as dairy alternatives. Dairy alternatives usually do not comprise dairy proteins. For example, such dairy alternatives may comprise alternative protein sources. The liquid food composition of the present invention contains pea protein. Hence, the present invention relates, for example, to a liquid food composition comprising pea protein isolate, sunflower oil, gellan gum, tribasic calcium phosphate, inulin, dipotassium phosphate, and water, wherein the liquid food composition does not comprise dairy proteins or added sugar.

The present invention relates generally to the field of liquid food compositions. In particular, the present invention relates to liquid food compositions that contain no added sugar and that can be used as dairy alternatives. Dairy alternatives usually do not comprise dairy proteins. For example, such dairy alternatives may comprise alternative protein sources. The liquid food composition of the present invention contains pea protein. Hence, the present invention relates, for example, to a liquid food composition comprising pea protein isolate, sunflower oil, gellan gum, tribasic calcium phosphate, inulin, dipotassium phosphate, and water, wherein the liquid food composition does not comprise dairy proteins or added sugar.

According to Codex Alimentarius, milk is the normal mammary secretion of milking animals obtained from one or more milkings without either addition to it or extraction from it, intended for consumption as liquid milk or for further processing.

Certain consumers wish to consume less milk or do not want to consume milk at all, for example, because of its animal origin, due to lactose intolerance or due to dairy allergies. They may also see potential environmental sustainability issues.

As a consequence, consumers seek for alternatives to milk. Alternatives to milk do exist and the dairy alternative market is growing by 11% each year and finding an alternative with good nutrition and taste will be a major advantage in this competitive field.

WO 2013078510 discloses a nut-based milk analogue composition that has a substantially similar nutritional profile as cow's milk.

CA2982280 discloses a method of producing a milk alternative, without necessarily adding a gum or emulsifier or starch, using chickpeas and/or other whole legumes or lentils (regular, sprouted or fermented), using pea protein, chickpea protein and/or a combination of plant-based protein (regular, sprouted or fermented), using flax seed oil and/or other vegetable oil, through high rotation mixing, heat and pressure, producing a very smooth mouthfeel.

Pea protein containing milk alternatives are commercially available.

However, consumers increasingly search for liquid food compositions that can be used as dairy alternatives that have an excellent nutritional value and a pleasant taste profile. In particular, there is a need for such liquid food compositions that are high in protein, fiber and calcium.

In particular the inclusion of fiber while maintaining a pleasant taste and texture profile appears to be difficult. In accordance with this US20130196028A1 discloses a method of making a chickpea soluble fraction, but which includes the removal of dietary fiber by filtration.

Also, if milk protein is replaced by plant protein sources, this often results in an unpleasant in taste, and the composition can be perceived as bitter and/or astringent.

To a certain extent the addition of sugar can help to mask unwanted off-tastes. However, many consumers wish to reduce their sugar intake and are looking for products without added sugar.

Overcoming the lack of the masking effect of sugar is hence an additional challenge in the preparation of a liquid food composition that can be used as milk alternative.

It would therefore be desirable to provide the art with a liquid food composition that can be used as milk alternative, contains fiber but no added sugar and that has a good nutritional profile and taste profile.

Any reference to prior art documents in this specification is not to be considered an admission that such prior art is widely known or forms part of the common general knowledge in the field.

The objective of the present invention is it to improve the state of the art and in particular to provide a liquid food composition that can be used as dairy alternative and that is high in protein, fiber and calcium, that does not contain added sugar and that provides a good nutritional profile, and a good taste profile, or to at least provide a useful alternative.

The inventors were surprised to see that the objective of the present invention could be achieved by the subject matter of the independent claims. The dependent claims further develop the idea of the present invention.

Accordingly, the present invention provides a liquid food composition comprising pea protein isolate, sunflower oil, gellan gum, tribasic calcium phosphate, inulin, dipotassium phosphate, and water, wherein the liquid food composition does not comprise dairy protein and added sugar.

As used in this specification, the words “comprises”, “comprising”, and similar words, are not to be interpreted in an exclusive or exhaustive sense. In other words, they are intended to mean “including, but not limited to”.

The present inventors have shown that the composition of the present invention achieves the objective of the present invention and—in particular—that a liquid food composition comprising pea protein isolate, sunflower oil, gellan gum, tribasic calcium phosphate, inulin, dipotassium phosphate, and water can be high in protein, high in calcium and high in fiber and achieves the objective of the present invention. The composition of the present invention was found to have a surprisingly pleasant taste profile despite the high pea protein and the high fiber content. The composition of the present invention was further found to be surprisingly stable in coffee and in tea, even without the addition of tripotassium citrate.

Hence, the invention relates to a liquid food composition comprising pea protein isolate, sunflower oil, gellan gum, tribasic calcium phosphate, inulin, dipotassium phosphate, and water, wherein the liquid food composition does not comprise dairy protein.

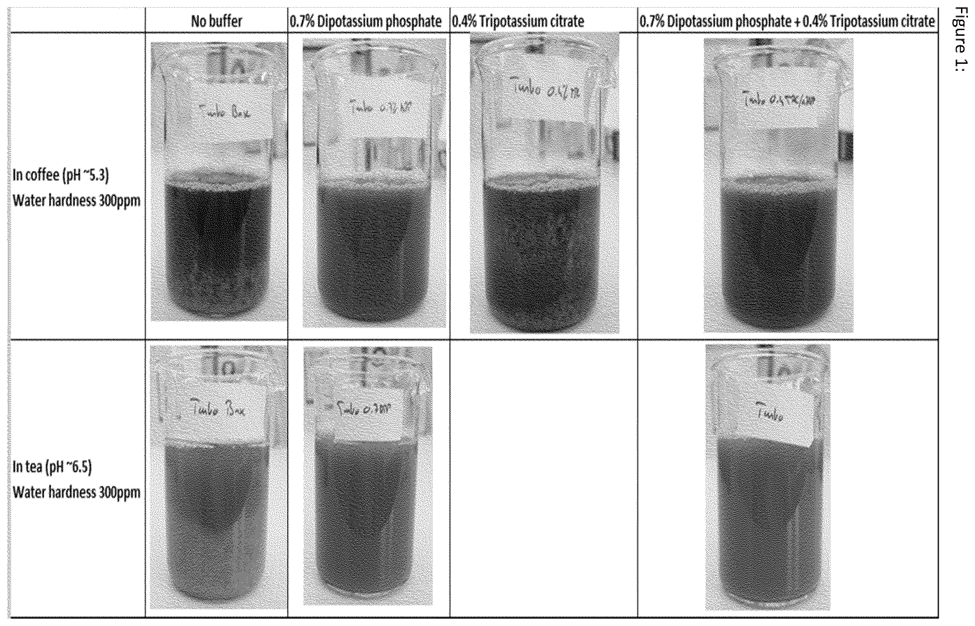

FIG. 1 shows the results of a stability test of the composition of the present in tea and in coffee.

Consequently, the present invention relates in part to a liquid food composition comprising pea protein isolate, sunflower oil, gellan gum, tribasic calcium phosphate, inulin, dipotassium phosphate, and water.

The liquid food composition in accordance with the present invention may not comprise dairy protein.

The liquid food composition in accordance with the present invention may further not comprise added sugar.

The term “food” shall be understood in accordance with Codex Alimentarius as any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

For the purpose of the present invention, a food may be considered high in fibre if the product contains at least 6 g of fibre per 100 g or at least 3 g of fibre per 100 kcal.

For the purpose of the present invention, a food may be considered high in protein, if at least 20% of the energy value of the food is provided by protein.

For the purpose of the present invention, a food may be considered high in calcium, if the product contains at least twice the value of ‘source of calcium’. A food may be considered a ‘source of calcium’ if the product contains at least a significant amount as defined in the Annex to Directive 90/496/EEC or an amount provided for by derogations granted according to Article 6 of Regulation (EC) No 1925/2006 of the European Parliament and of the Council of 20 Dec. 2006 on the addition of vitamins and minerals and of certain other substances to foods. 15% of the recommended allowance supplied by 100 g or 100 ml or per package if the package contains only a single portion should be taken into consideration in deciding what constitutes a significant amount.

The term “no added sugar” may be understood as foods without any added monosaccharides or disaccharides, or without any added food containing monosaccharides or disaccharides which is used for its sweetening purposes.

Pea protein isolate is commercially available from many sources, for example under the trademark Pisane from Cosucra. For example, Pisane C9 may be used.

Dairy proteins are milk proteins synthesized in the mammary gland and comprise caseins and whey proteins. For example, dairy proteins may comprise caseins, β-lactoglobulin, α-lactalbumin, blood serum albumin, immunoglobulins, lactoferrin, and transferrin.

Inulin is a plant-based fiber and can be obtained from many plant sources, chicory, for example. It is associated with many health benefits. It may improve digestive health, e.g., through its prebiotic properties, relieve constipation, promote weight loss and help control diabetes. Studies have shown that inulin can help stimulate the growth of beneficial bacteria in the gut, which may have positive effects on health.

The composition of the liquid food composition in accordance with the present invention may be adjusted so that the final composition has a good taste profile, a good nutritional profile and resembles the appearance and texture of milk. The inventors have obtained particularly promising results with a composition comprising per 100 ml about 2.5-3.0 g pea protein isolate, about 1.1-1.5 g sunflower oil, about 0.1-0.2 g gellan gum, about 2.0-3.0 g inulin, about 0.3-0.5 g tribasic calcium phosphate, and about 0.5-0.9 g dipotassium phosphate. The inventors were surprised to see that the addition of the dipotassium phosphate in the composition comprising inulin fibers resulted in a composition with a particularly pleasant mouthfeel and very little bitterness, astringency or other off-taste normally associated with pea protein. This is even more surprising as inulin is known to have properties as taste enhancer, and there is a worry that a taste enhance might enhance the “earthy”, “beany”, “bitter”, and “chalky” off-tastes pea-protein is well-known for.

If the composition of the present invention is used as milk alternative, many consumers may with to add the composition to hot milk of coffee, both of which are acidic beverages and—hence—often lead to unwanted protein coagulation. The inventors were surprised to see, that with the composition of the present invention such unwanted protein coagulation could be avoided. The inventors find further that if tripotassium citrate is added to the composition of the present invention, the stability of the liquid food composition of the present invention in hot tea or coffee can even further be increased. Hence, the composition of the present invention may further contain tripotassium citrate. Particularly promising results were obtained, if the composition of the present invention contained tripotassium citrate in an amount of about 0.3-0.5 g tripotassium citrate per 100 ml.

The inventors have attempted to even further improve the flavor profile of the composition of the present invention. For this, the inventors have successfully used flavoring agents. Hence, the liquid food composition in accordance with the present invention may further contains a flavoring agent or a combination of flavoring agents. For example, the flavoring agent may be selected from the group consisting of milk mouthfeel flavor, vanilla flavor, coconut flavor, almond flavor, or combinations thereof. Very good results were obtained, when the composition contained milk mouthfeel flavor as only flavoring agent. Also, very good results were obtained, when a combination of milk mouthfeel flavor and vanilla flavor, a combination of milk mouthfeel flavor and coconut flavor, or a combination of milk mouthfeel flavor and almond flavor were used.

As sunflower oil, any sunflower oil may be used. High quality sunflower oils are preferred. Sunflower oil can be considered a healthy oil with a high stability. Sunflower oil has a rich content of vitamin E. It also has a good fatty acid profile containing with linoleic acid a polyunsaturated fatty acid and with oleic acid a monounsaturated fatty acid. It is well-known that, for example through a specific cultivation of the sunflowers and through adjusted manufacturing processes, oils with different fatty acid proportions can be manufactured. Oleic acid has been associated with several health benefits such as decreased low-density lipoprotein (LDL) cholesterol, and reduce blood pressure, for example. Hence, some consumers may prefer an oil with a high oleic acid content. High oleic sunflower oil is known and commercially available. High oleic sunflower oil is very high in oleic acid. High oleic sunflower oil is usually defined as having a minimum 80 percent oleic acid. Consequently, in one embodiment of the liquid food composition of the present invention the sunflower oil may be high oleic sunflower oil.

Whole milk has an energy content of about 60 kcal/100 ml and milk with a 1% fat content has slightly above about 40 kcal/100 ml. Many consumers prefer products with a lower caloric content, and—hence—it would be desirable, if the composition of the present invention had a caloric content of 40 kcal/100 ml or below. The inventors were satisfied to see that the composition of the present invention achieves this. Hence, the liquid food composition in accordance with the present invention may have an energy content of 40 kcal/100 ml or below. For example, the liquid food composition in accordance with the present invention may have an energy density in the range of about 30-40 kcal/100 ml.

Milk is the first food. It is a rich source of nutrition a person needs. As such it provides good amounts of many of the nutrients necessary for the growth and maintenance of the human body. Many consumers would hence prefer, if a milk alternative also has a good nutritional profile.

In view of this, the composition of the present invention may be high in protein, high in fiber and/or high in calcium.

For example, the food composition of the present invention may comprise per 100 ml about 2.0-2.6 g protein, about 1.3-1.7 g fat, about 2.2-2.8 g carbohydrates, and about 1.8-2.8 g fiber.

The composition of the present may further be enriched with vitamins, for example vitamins A, D, B2, and/or B12.

For example, the liquid food composition in accordance with the present invention may comprise vitamins and minerals selected from the group consisting of calcium, vitamin A, vitamin D, vitamin B2 and vitamin B12. In one embodiment of the present invention, the liquid food composition of the present invention may comprise per 100 ml about 120-170 mg calcium, about 120-170 μg vitamin A, about 0.75-1.2 μg vitamin D, about 0.21-0.30 mg vitamin B2 and/or about 0.38-0.6 μg vitamin B12.

For example, the liquid food composition in accordance with the present invention may comprise per 100 ml about 2.5-3.0 g pea protein isolate, about 1.1-1.5 g sunflower oil, about 0.1-0.2 g gellan gum, about 2.0-3.0 g inulin, about 0.3-0.5 g tribasic calcium phosphate, about 0.5-0.9 g dipotassium phosphate, about 120-170 mg calcium, about 120-170 μg vitamin A, about 0.75-1.20 μg vitamin D, about 0.21-0.30 mg vitamin B2 and/or about 0.38-0.60 μg vitamin B12.

The inventors have, for example prepared a composition comprising per 100 ml about 2.8 g pea protein isolate, about 1.2 g sunflower oil, about 0.15 g gellan gum, about 2.7 g inulin, about 0.45 g tribasic calcium phosphate, about 0.7 g dipotassium phosphate, about 160 mg calcium, about 160 μg vitamin A, about 1.0 μg vitamin D, about 0.28 mg vitamin B2 and/or about 0.5 μg vitamin B12.

Oats are an excellent source of dietary fiber and are brought into association with many health benefits, such as—for example—a reduction of serum cholesterol levels in the body. Oats contain more soluble fiber than most other grains and are high in protein and healthy fats, and lower in carbohydrates than most other whole grains. Consequently, may breakfasts, such as porridge, for example are based on oats and several breakfast cereals are based on oats as well.

To further improve the nutritional profile of the composition of the present invention oat flour may be added to the composition of the present invention. The present inventors were surprised to see that this was possible without any substantial negative impact on the flavor profile and texture of the composition of the present invention.

Hence, the liquid food composition in accordance with the present invention may further comprise oat flour wholemeal. For example, the composition of the present invention may further comprise per 100 ml about 0.45-0.75 g oat flour wholemeal.

For example, the liquid food composition in accordance with the present invention may comprise per 100 ml about 2.5-3.0 g pea protein isolate, about 1.1-1.5 g sunflower oil, about 0.1-0.2 g gellan gum, about 2.0-2.4 g inulin, about 0.45-0.75 g oat flour wholemeal, about 0.3-0.5 g tribasic calcium phosphate, about 0.5-0.9 g dipotassium phosphate, about 120-170 mg calcium, about 120-170 μg vitamin A, about 0.75-1.20 μg vitamin D, about 0.21-0.30 mg vitamin B2 and/or about 0.38-0.60 μg vitamin B12.

The inventors have, for example prepared a composition comprising per 100 ml about 2.8 g pea protein isolate, about 1.2 g sunflower oil, about 0.15 g gellan gum, about 2.2 g inulin, about 0.55 g oat flour wholemeal, about 0.45 g tribasic calcium phosphate, about 0.7 g dipotassium phosphate, about 160 mg calcium, about 160 μg vitamin A, about 1.0 μg vitamin D, about 0.28 mg vitamin B2 and/or about 0.5 μg vitamin B12.

The liquid food composition in accordance with the present invention may be consumed warm, at ambient temperature or cooled. In may be preferred, if the liquid food composition in accordance with the present invention is stable at ambient temperatures, allowing distribution and storage without additional cooling facilities.

It may be used as drink. For example, the liquid food composition in accordance with the present invention may be to be used as a plant-based milk alternative. One advantage of composition of the present invention is it that it is stable in some acidic environments. Coffee, for example may have a pH of in the range of 5, tea typically may have a pH in the range of 6. The liquid food composition in accordance with the present invention may be stable in acidic food compositions, such as coffee or tea. “Stable” me be understood in this case as shows no visible protein coagulation during at least 10 minutes. Hence, the liquid food composition in accordance with the present invention may be to be used as coffee or tea whitener.

Those skilled in the art will understand that they can freely combine all features of the present invention disclosed herein. In particular, features described for the product of the present invention may be combined with the use of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the FIGURE and non-limiting examples.

### EXAMPLES

The inventors have prepared a liquid dairy alternative composition using per 100 ml 2,8 g pea protein isolate, 1.2 g sunflower oil, 0.15 g gellan gum, 0.45 g tribasic calcium phosphate and 2,7 g inulin.

To this composition they have added 0.7 g dipotassium phosphate to produce a liquid food composition in accordance with the present invention.

The composition was tested by an expert and found to be significantly less astringent and less bitter with the phosphate buffer system than without the phosphate buffer system.

The inventors have also assessed the stability of the liquid food composition in accordance with the present invention in tea and in coffee. The results are shown in FIG. 1. The inventors have prepared a liquid dairy alternative composition using per 100 ml 2,8 g pea protein isolate, 1.2 g sunflower oil, 0.15 g gellan gum, 0.45 g tribasic calcium phosphate and 2,7 g inulin; and have added to this composition dipotassium phosphate and/or tripotassium citrate to arrive at a concentration (w/v) of 0.7% dipotassium phosphate and/or 0.4% tripotassium citrate.

While without the phosphate buffer system precipitation was clearly detected, both in coffee and in tea, with the phosphate buffer system no precipitation was detected. The inventors further had the impression that the addition of tripotassium citrate led to an even increased stability of the composition of the present invention in tea and in coffee.

| | | | | 0.7% dipotassium |
|---|---|---|---|---|
| | | 0.7% | 0.4% | phosphate and |
| | | dipotassium | tripotassium | 0.4% tripotassium |
| | No buffer | phosphate | citrate | citrate |
| In Coffee | Precipitation | No | Precipitation | No |
| (pH 5.3) | | precipitation | | precipitation |
| Water | | | | |
| hardness | | | | |
| 300 ppm | | | | |
| In tea | Precipitation | No | Not tested | No |
| (pH 6.5) | | precipitation | | precipitation |
| Water | | | | |
| hardness | | | | |
| 300 ppm | | | | |

The inventors have further prepared the compositions as described below and have found that these compositions achieve the objective of the present invention.

| | Oat | |
|---|---|---|
| | unsweetened | Unsweetened |
| Pea protein isolate (g/100 ml) | 2.8 | 2.8 |
| Sunflower Oil High Oleic (g/100 ml) | 1.2 | 1.2 |
| Gellan gum (g/100 ml) | 0.15 | 0.15 |
| Calcium PhosTrbsc betaSSA Fine infG | 0.45 | 0.45 |
| (g/100 ml) | | |
| Inulin (g/100 ml) | 2.2 | 2.7 |
| DiPotassium Phosphate (g/100 ml) | 0.7 | 0.7 |
| TriPotassium Citrate (g/100 ml) | 0.4 | 0.4 |
| Oat flour wholemeal (g/100 ml) | 0.55 | |
| Flavor Milk Mouthfeel (g/100 ml) | 0.1 | 0.150 |
| Flavor Vanilla Firmenich (g/100 ml) | | 0.050 |

| | /100 ml | /100 ml |
|---|---|---|
| Energy (kcal) | 32 | 30 |
| Protein (g) | 2.4 | 2.3 |
| Fat (g) | 1.5 | 1.5 |
| SFA (g) | 0.1 | 0.1 |
| Carbohydrates (g) | 2.5 | 0.3 |
| Sugars (g) | 0.3 | 0.3 |
| Fibers (g) | 2.1 | 2.5 |
| Organic acid (g) | 0.24 | 0.24 |
| Sodium (mg) | 58 | 58 |
| Salt (g) | 0.15 | 0.15 |

| | Oat | |
|---|---|---|
| | unsweetened | Unsweetened |
| Calcium (mg) - Declared | 160 | 160 |
| Vitamin A (mcg) - Declared | 160 | 160 |
| Vitamin D (mcg) - Declared | 1.0 | 1.0 |
| Vitamin B2 (mg) - Declared | 0.28 | 0.28 |
| Vitamin B12 (mcg)- Declared | 0.5 | 0.5 |

1. Liquid food composition comprising pea protein isolate, sunflower oil, gellan gum, tribasic calcium phosphate, inulin, dipotassium phosphate, and water, wherein the liquid food composition does not comprise dairy protein and added sugar.

2. Liquid food composition in accordance with claim 1, wherein the composition comprises per 100 ml about 2.5-3.0 g pea protein isolate, about 1.1-1.5 g sunflower oil, about 0.1-0.2 g gellan gum, about 2.0-3.0 g inulin, about 0.3-0.5 g tribasic calcium phosphate, and about 0.5-0.9 g dipotassium phosphate.

3. Liquid food composition in accordance with claim 1, wherein the food composition further contains tripotassium citrate.

4. Liquid food composition in accordance with claim 1, wherein the food composition further contains a flavoring agent.

5. Liquid food composition in accordance with claim 4, wherein the flavoring agent is selected from the group consisting of milk mouthfeel flavor, vanilla flavor, coconut flavor, almond flavor, and combinations thereof.

6. Liquid food composition in accordance with claim 1, wherein the sunflower oil is high oleic sunflower oil.

7. Liquid food composition in accordance with claim 1, wherein the food composition has an energy density in the range of about 30-40 kcal/100 ml.

8. Liquid food composition in accordance with claim 1, wherein the food composition comprises per 100 ml about 2.0-2.6 g protein, about 1.3-1.7 g fat, about 2.2-2.8 g carbohydrates, and about 1.8-2.8 g fiber.

9. Liquid food composition in accordance with claim 1, further comprising vitamins and minerals selected from the group consisting of calcium, vitamin A, vitamin D, vitamin B2 and vitamin B12.

10. Liquid food composition in accordance with claim 9, wherein the liquid food composition comprises per 100 ml about 120-170 mg calcium, about 120-170 vitamin A, about 0.75-1.2 μg vitamin D, about 0.21-0.30 mg vitamin B2 and/or about 0.38-0.6 vitamin B12.

11. Liquid food composition in accordance with claim 1, wherein the liquid food composition comprises per 100 ml about 2.5-3.0 g pea protein isolate, about 1.1-1.5 g sunflower oil, about 0.1-0.2 g gellan gum, about 2.0-3.0 g inulin, about 0.3-0.5 g tribasic calcium phosphate, about 0.5-0.9 g dipotassium phosphate, about 120-170 mg calcium, about 120-170 μg vitamin A, about 0.75-1.20 μg vitamin D, about 0.21-0.30 mg vitamin B2 and/or about 0.38-0.60 μg vitamin B12.

12. Liquid food composition in accordance with claim 1, wherein the liquid food composition comprises per 100 ml about 0.45-0.75 g oat flour wholemeal.

13. Liquid food composition in accordance with claim 1, wherein the liquid food composition is to be used as a plant-based milk alternative.

14. Liquid food composition in accordance with claim 1, wherein the liquid food composition is stable in acidic food compositions.
